(19) United States
(12) Patent Application Publication
(10) Pub. No.: US 2011/0115376 A1
(43) Pub. Date: May 19, 2011

(54) LIGHTING DEVICE FOR VEHICLE

(75) Inventors: Masanori SHIRATSUCHI, Kawasaki-shi (JP); Yoshitaka TANABE, Kawasaki-shi (JP); Youichi TAKANO, Kawasaki-shi (JP)

(73) Assignee: FALTEC CO., LTD., Kawasaki-shi (JP)

(21) Appl. No.: 12/947,347

(22) Filed: Nov. 16, 2010

(30) Foreign Application Priority Data
Nov. 18, 2009 (JP) 2009-262979

(51) Int. Cl. B60Q 1/14; B60Q 1/00

(52) U.S. Cl. 315/77; 362/459

(57) ABSTRACT

A lighting device for a vehicle includes inner sill lamps that illuminate a floor in a cabin. Each of the inner sill lamps is provided on each side surface of inner sill covers. The side surfaces faces to the cabin. The lighting device can sufficiently illuminate the floor without illuminance reduction due to an object such as an instrument panel or a seat disposed between the inner sill lamps and the floor. In addition, the lighting device can surely illuminate the floor around a user's feet when the user gets in or off the vehicle.

### CROSS-REFERENCE TO RELATED APPLICATION

This application is based upon and claims the benefit of Japanese Patent Application No. 2009-262979, filed on Nov. 18, 2009; the entire contents of which are incorporated herein by reference for all purposes.

### BACKGROUND OF THE INVENTION

1. Field of the Invention

The present invention relates to a lighting device for a vehicle, and more particularly to a lighting device for lighting floor in a cabin.

2. Description of the Related Art

As a conventional lighting device for a vehicle, various types of devices that illuminate a cabin floor have been proposed. Japanese Utility Model Application Laid-Open No. S58-124346 (Patent document 1) and Japanese Patent Application Laid-Open No. H4-129856 (Patent document 2) disclose lighting devices that is a foot lamp mounted on a lower portion of an instrument panel. Japanese Utility Model Application Laid-Open No. H6-33738 (Patent document 3) discloses a lighting device that is a foot lamp mounted on a steering column cover.

### SUMMARY OF THE INVENTION

However, the foot lamp is distant from the floor in the above-mentioned conventional lighting devices. As a result, the floor cannot be illuminated with sufficient illuminance. Further, a distance between the foot lamp and the floor is long, so that light from the foot lamp may be obscured by an object such as an instrument panel or a seat disposed between the foot lamp and the floor. In this case, the floor cannot be illuminated sufficiently.

The lighting devices disclosed in Patent document 1 and 2 may illuminate a floor around user's feet when a user sits on a seat. However, the lighting devices cannot surely illuminate the floor around the user's feet when the user is getting in or off the vehicle.

The present invention has been made to overcome the above-mentioned problems, and it is an object of the present invention to provide a lighting device for a vehicle that can sufficiently illuminate a floor in a cabin without illuminance reduction due to an object such as an instrument panel or a seat disposed between the lighting device and the floor, and can surely illuminate the floor around a user's feet when the user is getting in or off the vehicle.

According to an aspect of the present invention provides a lighting device for a vehicle that includes a floor lamp that illuminates a floor in a cabin, wherein the floor lamp is provided below a door opening and in an inside of the cabin.

According to the aspect of the present invention, the floor lamp is provided close to the floor in the cabin. Accordingly, the floor lamp can sufficiently illuminate the floor in the cabin without illuminance reduction due to an object such as an instrument panel or a seat disposed between the floor lamp and the floor.

It is preferable that the floor lamp is mounted on an inner sill cover that is disposed below the door opening and in the inside of the cabin.

According to this configuration, the floor lamp can efficiently illuminate the floor in the cabin without illuminance reduction due to an object such as an instrument panel or a seat disposed between the floor lamp and the floor.

In addition, the inner sill cover is mounted closest to a floor on which user's feet are put when a user gets in or off the vehicle. Accordingly, it is possible to surely illuminate the floor around the user's feet at the time of getting in or off the vehicle at night (a dark place).

It is further preferable that the floor lamp is disposed on a side surface of the inner sill cover. Note that the side surface faces to the cabin.

According to this configuration, mounting of the floor lamp on the inner sill cover does not cause a height elevation of the inner sill cover. Accordingly, a user can smoothly get in or off the vehicle without being obstructed by the inner sill cover.

It is further preferable that the floor lamp includes a light guide plate that has a long flat planar shape and a plurality of light sources, the light guide plate is arranged along a longitudinal direction of the inner sill cover, and has a light incident surface and a light irradiation surface, and the plurality of light sources is arranged at intervals in a longitudinal direction of the light guide plate and irradiates lights toward the light incident surface of the light guide plate. Here, the light guide plate guides the lights from the plurality of light sources therethrough while diffusely reflecting the lights therewithin, and then irradiates the lights outward from the light irradiation surface.

According to this configuration, the floor lamp does not largely project toward the cabin from the inner sill cover, and the lights can be irradiated widely. Accordingly, the floor lamp can illuminate a wide range without substantially narrowing a user's space. In addition, the floor lamp can irradiate light with even illuminance from the light irradiation surface along the longitudinal direction.

It is preferable that the lighting device further includes a door open/close detector that detects opening and closing of a door, wherein the floor lamp is turned on when opening of the door is detected by the door open/close detector.

According to this configuration, a user can smoothly get in or off the vehicle at night (a dark place).

### BRIEF DESCRIPTION OF THE DRAWINGS

FIG. 1 is a perspective view showing a part of a cabin in an embodiment;

FIG. 2A is a cross-sectional view showing a position of an inner sill lamp when a door is closed;

FIG. 2B is a cross-sectional view showing the position of the inner sill lamp when the door is opened;

FIG. 3 is a cross-sectional view of the inner sill lamp;

FIG. 4 is an exploded perspective view of the inner sill lamp; and

FIG. 5 is a schematic plan view of a vehicle with light irradiation ranges of the inner sill lamps.

### DESCRIPTION OF THE PREFERRED EMBODIMENTS

Hereinafter, a lighting device for a vehicle according to an embodiment is explained with reference to the drawings.

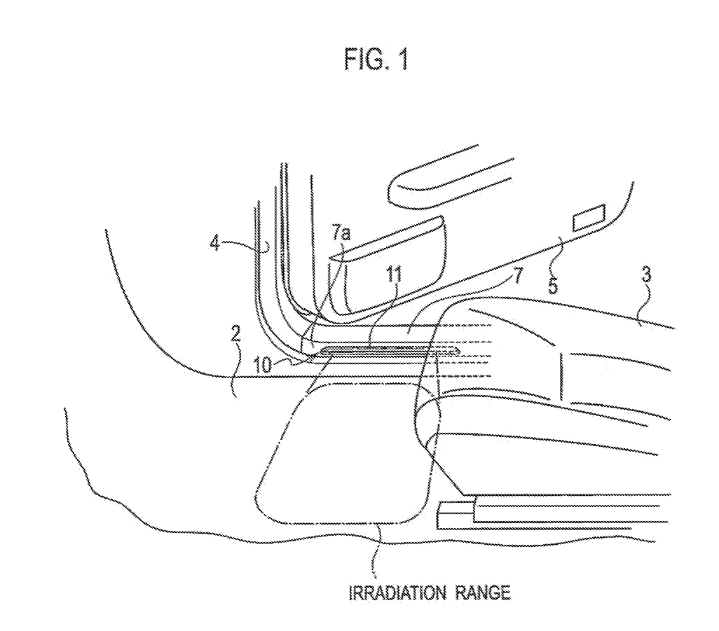

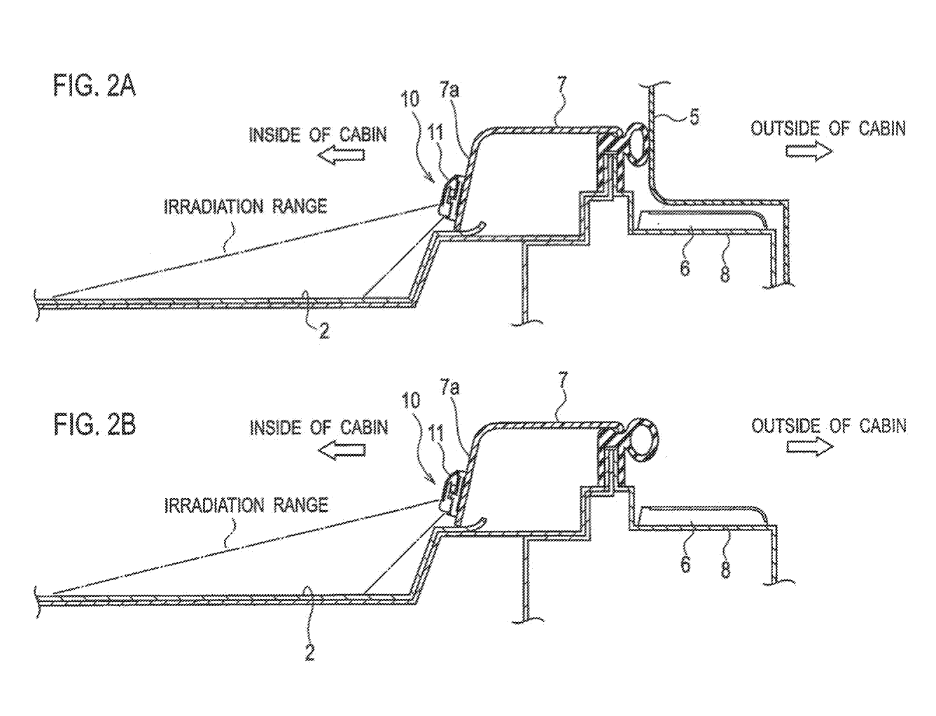

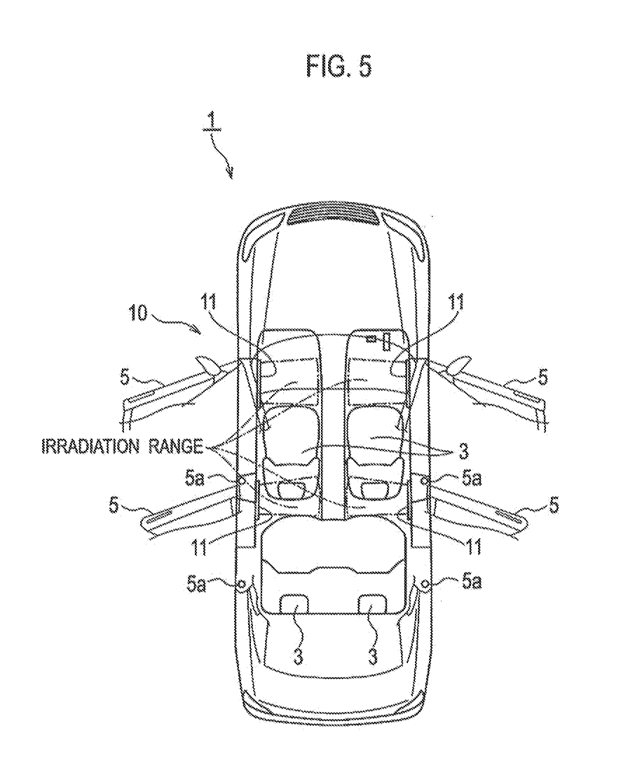

As shown in FIG. 1, FIG. 2A, FIG. 2B and FIG. 5, four seats 3 are provided on a floor 2 inside a cabin of the vehicle 1. Two of the seats 3 are provided on a front side and remaining two of the seats 3 are provided on a rear side. Door openings 4 are provided on sides of the vehicle 1 corresponding to the seats 3, respectively. The door openings 4 are opened or closed by doors 5, respectively. Kicking plates 6 are fixed to an outer body panel 8 below the door openings 4, respectively. Inner sill covers 7 are fixed to the floor 2 at positions closest to a cabin inner side of the kicking plates 6, respectively. Each of the inner sill covers 7 is arranged parallel to each of the kicking plates 6. The inner sill covers 7 are located higher than the kicking plates 6, respectively.

A lighting device 10 includes four inner sill lamps (floor lamps) 11. The inner sill lamps 11 are disposed on side surfaces 7a of the inner sill covers 7, respectively. Each of the inner sill lamps 11 illuminates the floor 2 in front of each of the seats 3 widely. The detailed constitution of the inner sill lamp 11 is described later.

The lighting device 10 includes door switches (door open/close detector) 5a (see FIG. 5), floor lighting switches (not shown in the drawing), and a controller. The door switches 5a detect opening and closing of the doors 5, respectively. By the floor lighting switch, a user can control turning on and off of the inner sill lamp 11. Detection information of the door switches 5a and operation information of the floor lighting switches are outputted to the controller. When the door switch 5a detects opening of the door 5, the controller turns on the inner sill lamp 11 corresponding to the door 5. When the door switch 5a detects closing of the door 5, the controller turns off the inner sill lamp 11 corresponding to the door 5. Further, when the floor lighting switch is turned on, the controller turn on the inner sill lamp 11 even while the door 5 is closed.

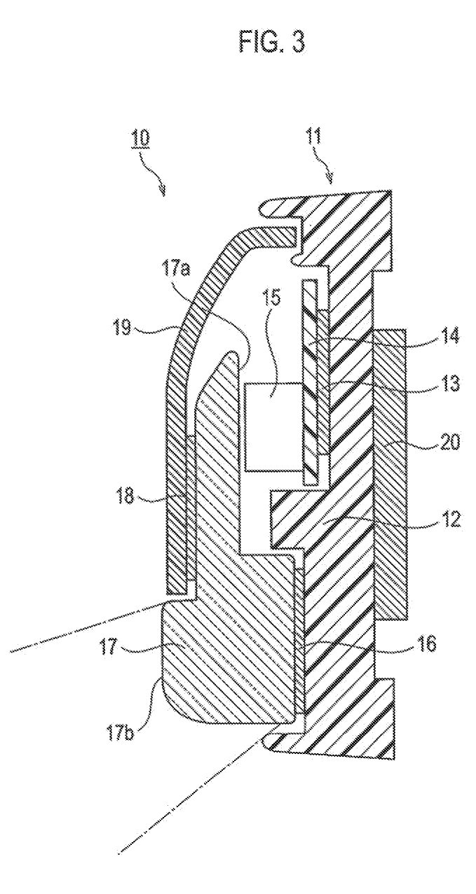

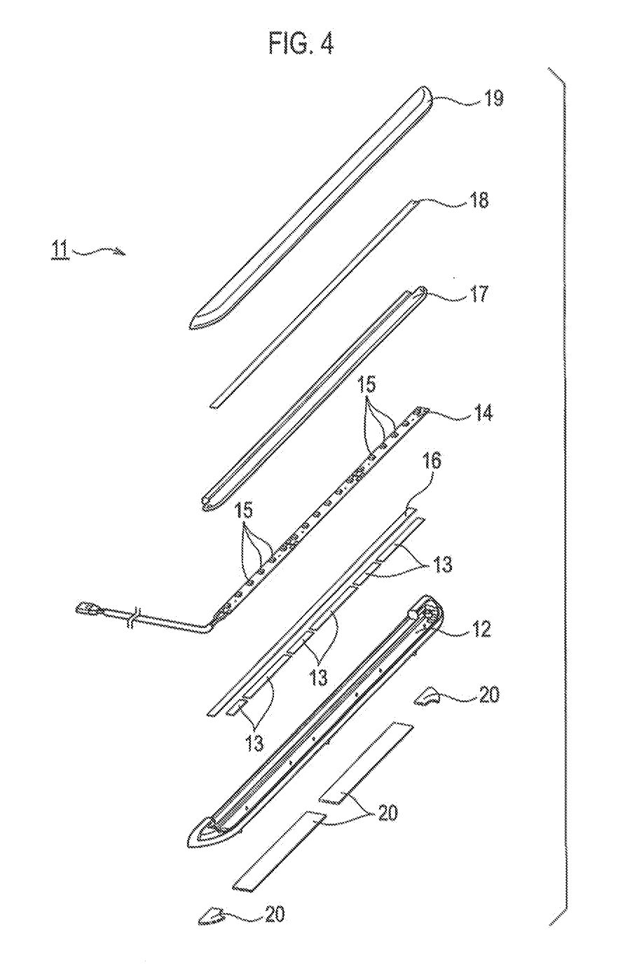

Next, configuration of the inner sill lamp 11 is explained. As shown in FIG. 3 and FIG. 4, the inner sill lamp 11 includes a base member 12 made of resin, a printed circuit board 14, light emitting diodes (light sources) 15, a light guide plate 17, and a light shielding cover 19. The base member 12 has light shielding property. The printed circuit board 14 is fixed to a surface of the base member 12 by double-faced adhesive tapes 13. Wiring patterns are formed on the printed circuit board 14. The light emitting diodes 15 are mounted on a surface of the printed circuit board 14 at intervals. The light guide plate 17 is fixedly mounted on the base member 12 by a double-faced adhesive tape 16. The light shielding cover 19 is fixedly mounted on the light guide plate 17 by a double-faced adhesive tape 18 to cover the printed circuit board 14 and so on. Each of the base member 12, the printed circuit board 14, the light guide plate 17 and the light shielding cover 19 is formed into a long flat shape. Accordingly, the inner sill lamp 11 is formed into a long flat planar shape, and arranged along a longitudinal direction of the inner sill cover 7.

In the inner sill lamp 11, a rear surface of the base member 12 is fixed to the inner sill cover 7 by a double-faced adhesive tape 20 along the longitudinal direction of the inner sill cover 7 (a vehicle longitudinal direction).

The light guide plate 17 is an opaque white light-transmitting member with a long flat shape. The light guide plate 17 guides lights entered thereinto from the light emitting diodes 15 through its light incident surface 17a while diffusely reflecting the lights therewithin, and then irradiates the lights outward from its light irradiation surface 17b. Accordingly, although the light emitting diodes 15 are arranged at intervals, the lights with substantially even illuminance are irradiated from the light irradiation surface 17b along the longitudinal direction. The light irradiation surface 17b is exposed between the base member 12 and the light shielding cover 19. The light irradiation surface 17b is arranged along the longitudinal direction of the vehicle 1 so as to radiate the lights toward the floor 2 of the cabin.

Each of the light emitting diodes 15 has a light irradiating surface facing to the light incident surface 17a of the light guide plate 17.

Next, the lighting operations of the lighting device 10 are explained.

When a user approaches the vehicle 1 and opens the door 5, the door switch 5a corresponding to the door 5 detects opening of the door 5. As a result, the inner sill lamp 11 corresponding to the door 5 is turned on. When all of the doors 5 are opened as shown in FIG. 5, all of the inner sill lamps 11 are turned on. In this manner, when the door 5 is opened, the floor 2 in the cabin on which the user are going to get on is illuminated by the inner sill lamp 11. Accordingly, the user can smoothly get in the vehicle 1 at night (a dark place). When the user closes the door 5 after getting in the vehicle 1, the door switch 5a corresponding to the door 5 detects closing of the door 5. As a result, the inner sill lamp 11 is turned off.

When a user turns on the floor lighting switch (not shown) during driving or the like, the inner sill lamp 11 corresponding to the seat 3 is turned on. Accordingly, the floor 2 around user's feet is illuminated by the inner sill lamp 11, so that a user can easily find an object for which the user is searching on the floor 2.

When a user opens the door 5 to get off the vehicle 1, the door switch 5a corresponding to the door 5 detects opening of the door 5. As a result, the inner sill lamp 11 corresponding to the door 5 is turned on. When all of the doors 5 are opened as shown in FIG. 5, all of the inner sill lamps 11 are turned on. In this manner, when the user opens the door 5, the floor 2 on which the user's feet are put until he gets off the vehicle 1 is illuminated by the inner sill lamp 11. Accordingly, the user can smoothly get off the vehicle 1 at night (a dark place). When the user closes the door 5 after getting off the vehicle 1, the door switch 5a corresponding to the door 5 detects closing of the door 5. As a result, the inner sill lamp 11 is turned off.

As explained above, the inner sill lamp 11 that illuminates the floor 2 in the cabin is mounted on the inner sill cover 7. In this manner, the inner sill lamp 11 is mounted on the inner sill cover 7 disposed close to the floor 2 in the cabin. Accordingly, the inner sill lamp 11 can sufficiently illuminate the floor 2 in the cabin without illuminance reduction due to an object such as an instrument panel or the seat 3 disposed between the inner sill lamp 11 and the floor 2.

In addition, the inner sill cover 7 is mounted at a position closest to the floor 2 on which the user's feet are put when the user gets in or off the vehicle 1. Accordingly, it is possible to surely illuminate the floor 2 around the user's feet at the time of getting in or off the vehicle 1. As a result, the user can smoothly get in or off the vehicle 1 at night (a dark place).

The inner sill lamp 11 is disposed on the side surface 7a of the inner sill cover 7. Accordingly, mounting of the floor lamp 11 on the inner sill cover 7 does not cause a height elevation of the inner sill cover 7. As a result, a user can smoothly get in or off the vehicle 1 without being obstructed by the inner sill cover 7.

The inner sill lamp 11 is constituted of the light guide plate 17 having the light incident surface 17a and the light irradiation surface 17b, and the light emitting diodes 15 arranged in the longitudinal direction of the light guide plate 17, as explained above. Accordingly, the inner sill lamp 11 has a long flat planar shape so as not to project largely toward the cabin from the inner sill cover 7, and the lights from the light irradiation surface 17b can be irradiated widely. As a result, the inner sill lamp 11 can illuminate a wide range without substantially narrowing a user's space. In addition, the inner sill lamp 11 can irradiate lights with substantially even illuminance from the light irradiation surface 17b along the longitudinal direction.

The lighting device 10 includes the door switch 5a that detects opening and closing of the door 5, and the inner sill lamp 11 is turned on when opening of the door 5 is detected by the door switch 5a. Accordingly, a user can smoothly get in or off the vehicle 1 at night (a dark place).

Although the floor lamp is constituted of the inner sill lamp 11 on the inner sill in this embodiment, the floor lamp may be disposed at any position below the door opening 4 and in the inside of the cabin other than a position on the inner sill cover 7. That is, the above-described position is close to the floor 2, so that the inner sill lamp 11 can sufficiently illuminate the floor 2 in the cabin without illuminance reduction due to an object such as an instrument panel or the seat 3 disposed between the inner sill lamp 11 and the floor 2.

Although the inner sill lamp 11 is turned on when the door 5 is opened in this embodiment, it may be suitably determined when turning on the inner sill lamp 11. For example, the inner sill lamp 11 may be turned on at a time when detected is an approach of a user who has a key or a transmitter to be perceived toward the vehicle 1, or a time when unlocking of the door 5 by a remote key is detected.

Although the inner sill lamp 11 is turned off when the door 5 is closed in this embodiment, it may be suitably determined when turning off the inner sill lamp 11. For example, in a case of getting in the vehicle 1, the inner sill lamp 11 may be turned off at a time when an ignition key is turned on from an OFF state.

Although the rear surface of the base member 12 of the inner sill lamp 11 is fixedly mounted on the inner sill cover 7 by the double-faced adhesive tape 20 in this embodiment, the base member 12 may be fixedly mounted on the inner sill cover 7 by any suitable element. For example, the rear surface of the base member 12 of may be fixedly mounted on the inner sill cover 7 using a screw (s), a retainer (bracket) or a combination of a double-faced adhesive tape (s) and such a fixing element.

Although the invention has been described above by reference to a certain embodiment of the invention, the invention is not limited to the embodiment described above. Modifications and variations of the embodiment will occur to those skilled in the art, in light of the above teachings. The scope of the invention is defined with reference to following claims.

What is claimed is:

1. A lighting device for a vehicle, comprising:
a floor lamp that illuminates a floor in a cabin, wherein
the floor lamp is provided below a door opening and in an inside of the cabin.

2. The lighting device according to claim 1, wherein
the floor lamp is mounted on an inner sill cover that is disposed below the door opening and in the inside of the cabin.

3. The lighting device according to claim 2, wherein
the floor lamp is disposed on a side surface of the inner sill cover, the side surface facing to the cabin.

4. The lighting device according to claim 2, wherein
the floor lamp includes a light guide plate that has a long flat planar shape and a plurality of light sources,
the light guide plate is arranged along a longitudinal direction of the inner sill cover, and has a light incident surface and a light irradiation surface,
the plurality of light sources is arranged at intervals in a longitudinal direction of the light guide plate and irradiates lights toward the light incident surface of the light guide plate, and
the light guide plate guides the lights from the plurality of light sources therethrough while diffusely reflecting the lights therewithin, and then irradiates the lights outward from the light irradiation surface.

5. The lighting device according to claim 1, further comprising a door open/close detector that detects opening and closing of a door, wherein
the floor lamp is turned on when opening of the door is detected by the door open/close detector.
